(19) United States
(12) Patent Application Publication
(10) Pub. No.: US 2026/0249966 A1
(43) Pub. Date: Aug. 27, 2026

(54) AUTONOMOUS NAVIGATION SHIP

(71) Applicant: SOFTBANK GROUP CORP., Tokyo (JP)

(72) Inventor: Masayoshi SON, Tokyo (JP)

(21) Appl. No.: 19/162,843

(22) PCT Filed: Mar. 6, 2024
(86) PCT No.: PCT/JP2024/008560

§ 371 Date: Sep. 5, 2025

(30) Foreign Application Priority Data
Mar. 15, 2023 (JP) 2023-041040
May 23, 2023 (JP) 2023-084625
Jun. 1, 2023 (JP) 2023-091080
Jun. 1, 2023 (JP) 2023-091119

(51) Int. Cl. B63B 79/40; B63B 1/24; B63B 79/15; B63H 21/17; B63H 25/04; B63H 25/38; G05D 1/43; G05D 1/644; G05D 109/30

(52) U.S. Cl. CPC B63B 79/40; B63B 1/242; B63B 79/15; B63H 21/17; B63H 25/04; B63H 25/38; G05D 1/43; G05D 1/644; G05D 2109/36

(57) ABSTRACT

An autonomous navigation ship includes a hull, a fore-and-aft sail, an information collection device, a control device, a positioning device, an autonomous navigation device, and a wing sail. The fore-and-aft sail is stretched on a mast erected on the hull. The information collection device collects weather information and ocean information around the hull. The control device controls the direction of the fore-and-aft sail such that the propulsive force of the hull is maximized, based on the weather information and the ocean information The positioning device measures a position of the hull. The autonomous navigation device controls a rudder to navigate the hull from a current position to a destination point, based on the position of the hull. The wing sail is provided on both sides of the hull, and floats the hull by applying lift force to the hull during navigation.

### FIELD

Embodiments of the disclosure relate to an autonomous navigation ship.

### BACKGROUND

In the related art, there is a ship that navigates using a motor driven by electric power of a battery as a driving source and includes a control unit that automatically controls ship maneuvering from a current position to a destination point using a global positioning system (GPS) or the like (e.g., see Patent Literature 1).

### CITATION LIST

### Patent Literature

Patent Literature 1: JP 2017-178281 A

### SUMMARY

### Technical Problem

However, in an autonomous navigation ship that navigates using a motor driven by electric power of a battery as a driving source, the battery needs to be charged by a commercial power supply or the like in order to navigate, and the cost required for navigation increases.

An aspect of an embodiment has been made in view of the above, and an object thereof is to provide an autonomous navigation ship capable of reducing the cost required for navigation.

### Solution to Problem

An autonomous navigation ship according to one aspect of an embodiment includes a hull, a fore-and-aft sail, an information collection device, a control device, a positioning device, an autonomous navigation device, and a wing sail. The fore-and-aft sail is stretched on a mast erected on the hull. The information collection device collects weather information and ocean information around the hull. The control device controls the direction of the fore-and-aft sail such that the propulsive force of the hull is maximized, based on the weather information and the ocean information collected by the information collection device. The positioning device measures a position of the hull. The autonomous navigation device controls a rudder to navigate the hull from a current position to a destination point, based on the position of the hull measured by the positioning device. The wing sail is provided on both sides of the hull, and floats the hull by applying lift force to the hull during navigation.

### Advantageous Effects of Invention

An autonomous navigation ship according to an aspect of an embodiment has an effect of capable of reducing the cost required for navigation.

### BRIEF DESCRIPTION OF DRAWINGS

FIG. 1 is an explanatory side view of an autonomous navigation ship according to a first embodiment.

FIG. 2 is an explanatory front view of the autonomous navigation ship according to the first embodiment.

FIG. 3 is an explanatory top view of the autonomous navigation ship according to the first embodiment.

FIG. 4 is a functional block diagram illustrating an internal configuration example of the autonomous navigation ship according to the first embodiment.

FIG. 5 is an explanatory side view of the autonomous navigation ship according to the first embodiment during navigation.

FIG. 6 is an explanatory view of a flapping motion of a wing sail according to the first embodiment.

FIG. 7 is an explanatory side view of an autonomous navigation ship according to a second embodiment.

FIG. 8 is a functional block diagram illustrating an internal configuration example of the autonomous navigation ship according to the second embodiment.

FIG. 9 is an explanatory diagram illustrating selection of a route of the autonomous navigation ship according to the second embodiment.

FIG. 10 is an explanatory diagram illustrating selection of a route of the autonomous navigation ship according to the second embodiment.

FIG. 11 is a flowchart illustrating an example of a process performed by an autonomous navigation device according to a third embodiment.

FIG. 12 is a flowchart illustrating an example of a process performed by the autonomous navigation device according to the third embodiment.

### DESCRIPTION OF EMBODIMENTS

Embodiments of an autonomous navigation ship will be described in detail below with reference to the accompanying drawings. Note that the present invention is not limited to the embodiments described below.

### 1. First Embodiment

### 1-1. Appearance of Autonomous Navigation Ship According to First Embodiment

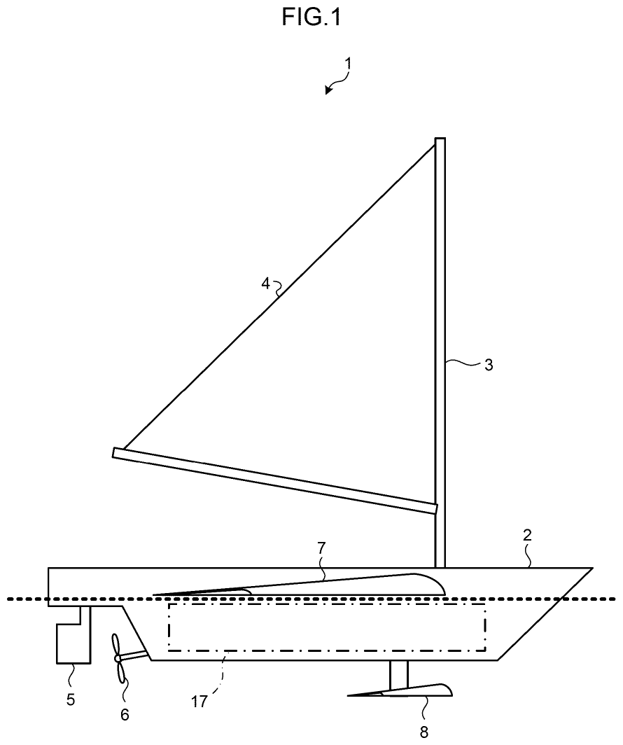

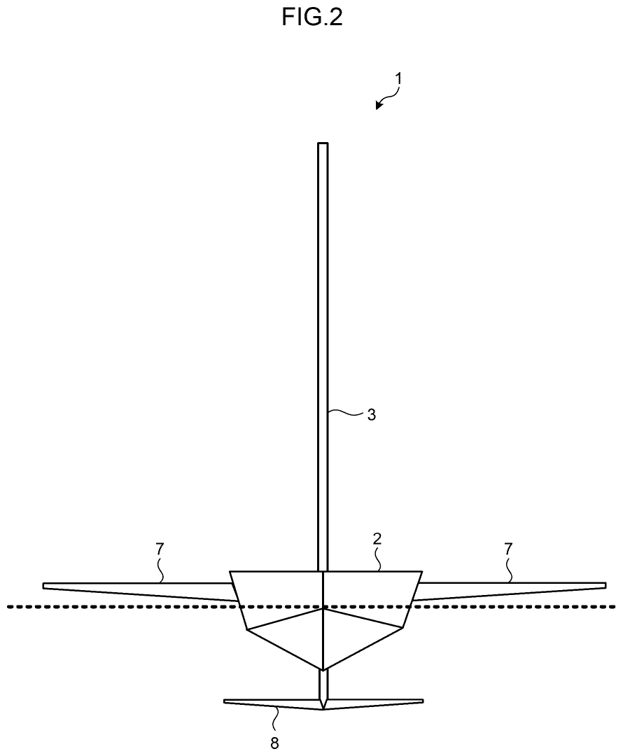

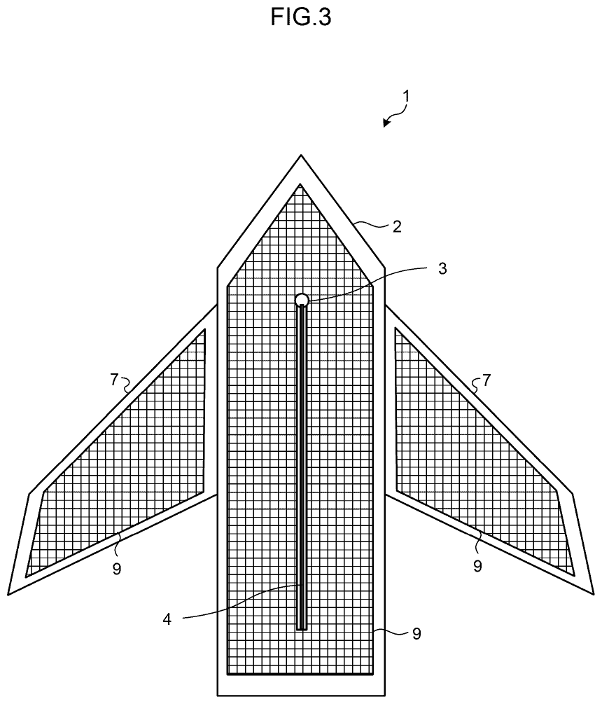

First, the appearance of an autonomous navigation ship according to a first embodiment will be described with reference to FIGS. 1 to 3. FIG. 1 is an explanatory side view of an autonomous navigation ship 1 according to the first embodiment. FIG. 2 is an explanatory front view of the autonomous navigation ship 1 according to the first embodiment. FIG. 3 is an explanatory top view of the autonomous navigation ship 1 according to the first embodiment. Note that FIGS. 1 and 2 illustrate an autonomous navigation ship at rest. The dotted lines illustrated in FIGS. 1 and 2 indicate a water surface.

As illustrated in FIGS. 1 to 3, the autonomous navigation ship 1 according to the first embodiment includes a hull 2, a mast 3, a fore-and-aft sail 4, a rudder 5, a screw 6, a wing sail 7, and a hydrofoil 8. The autonomous navigation ship 1 is used for transporting cargo, and includes a space 17 in which cargo can be stored inside the hull 2, as indicated by a one-dot chain line in FIG. 1. The mast 3 is erected on the hull 2. The fore-and-aft sail 4 is stretched on the mast 3. The mast 3 applies a propulsive force to the hull 2 by receiving wind.

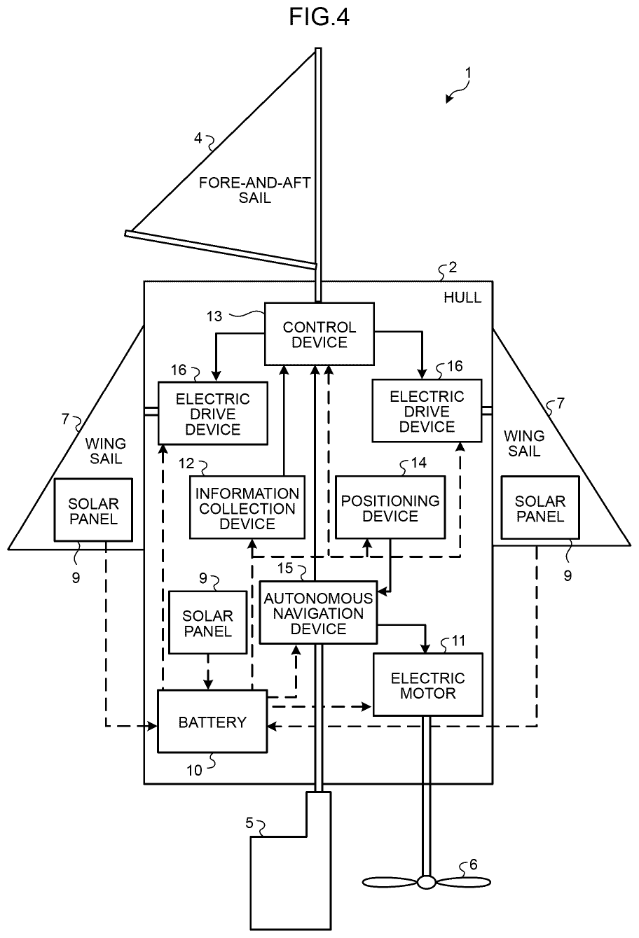

The rudder 5 is provided on the rear bottom of the hull 2. The rudder 5 is driven by an autonomous navigation device 15 (see FIG. 4), which will be described later, to change the course of the hull 2. The screw 6 is rotationally driven by an electric motor 11 (see FIG. 4) provided in the hull 2 to apply a propulsive force to the hull 2.

In other words, the autonomous navigation ship 1 is a hybrid ship that navigates by converting wind force and electric power into a propulsive force. Therefore, the autonomous navigation ship 1 can reduce the cost required for navigation by reducing the consumption of electric power and fossil fuel as compared with a ship that navigates only with electric power or only with fossil fuel.

In addition, the wing sail 7 is provided on both sides of the hull 2. Specifically, the wing sail 7 is provided to protrude toward the outside of the hull 2 from each of the right side surface and the left side surface with the traveling direction of the hull 2 as a reference. The wing sail 7 also has a shape imitating a main wing of an airplane. Thus, the wing sail 7 can float the hull 2 by applying a lift force to the hull 2 during navigation, that is, during forward movement.

The hydrofoil 8 is provided on the bottom surface of the hull 2, that is, on the bottom of the ship. The hydrofoil 8 has a shape imitating a main wing of an airplane. Thus, the hydrofoil 8 can float the hull 2 by applying a lift force to the hull 2 during navigation, that is, during forward movement.

In addition, a solar panel 9 that converts sunlight into electricity is provided on the upper surface of the wing sail 7, that is, on the surface opposite to the side facing the water surface. Further, a solar panel 9 is provided on the deck of the hull 2. The electric power generated by the solar panel 9 is supplied to the electric motor 11 (see FIG. 4) that drives the screw 6.

### 1-2. Internal Configuration of Autonomous Navigation Ship According to First Embodiment

An internal configuration of the autonomous navigation ship 1 according to the first embodiment will now be described with reference to FIG. 4. FIG. 4 is a functional block diagram illustrating an internal configuration example of the autonomous navigation ship 1 according to the first embodiment. Here, the same components as the components illustrated in FIGS. 1 to 3 are denoted by the same reference numerals as the reference numerals illustrated in FIGS. 1 to 3, and thus redundant description will be omitted.

As illustrated in FIG. 4, the autonomous navigation ship 1 includes, inside the hull 2, a battery 10, an electric motor 11, an information collection device 12, a control device 13, a positioning device 14, an autonomous navigation device 15, and an electric drive device 16.

The battery 10 is a chargeable/dischargeable secondary battery. For example, the battery 10 is a lithium-ion (Li) battery. The battery 10 stores electricity generated by the solar panel 9, and supplies power to the electric motor 11, the information collection device 12, the control device 13, the positioning device 14, the autonomous navigation device 15, and the electric drive device 16. The electric motor 11 is driven and controlled by the autonomous navigation device 15.

The information collection device 12 is configured to be able to communicate with a weather satellite and a weather server installed on land. The information collection device 12 receives and collects weather information and ocean information around the hull 2 from at least one of a weather satellite and a weather server.

For example, the information collection device 12 collects information such as weather forecasts, atmospheric pressure distribution, satellite photography, the direction and speed of ocean currents, the height of waves, or the like around the hull 2, and outputs the information to the control device 13. Note that the information collection device 12 may further include various sensors such as a wind speed sensor, a wind direction sensor, and an atmospheric pressure sensor, and may be configured to acquire weather information and ocean information by the various sensors.

The control device 13 includes a microcomputer having a central processing unit (CPU), a read only memory (ROM), a random access memory (RAM), and the like, and various circuits. The control device 13 controls the fore-and-aft sail 4 and the electric drive device 16 by the CPU executing a program stored in the ROM using the RAM as a work area.

Note that a part or all of the control device 13 may be configured by hardware such as an application specific integrated circuit (ASIC) or a field programmable gate array (FPGA).

The control device 13 includes artificial intelligence (AI), and the AI controls the direction of the fore-and-aft sail 4 such that the propulsive force of the hull 2 is maximized, based on the weather information and the ocean information collected by the information collection device 12.

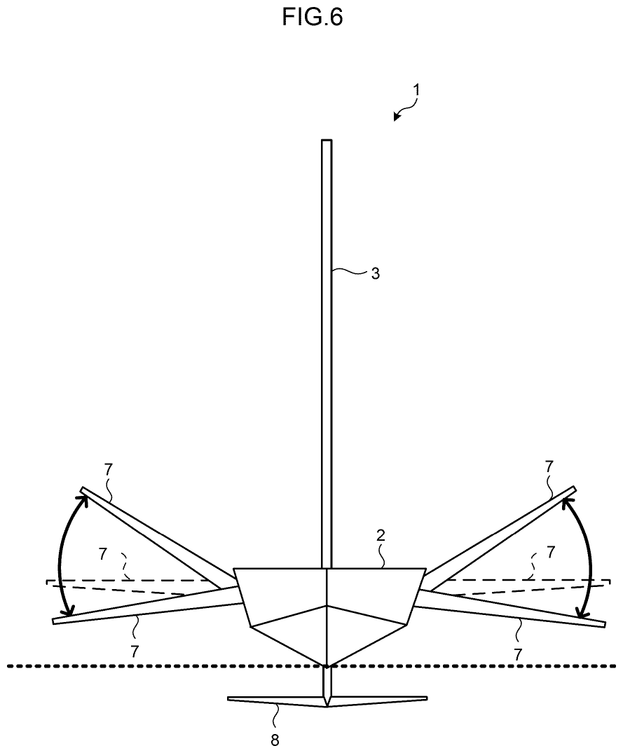

Thus, since the AI always adjusts the direction of the fore-and-aft sail 4 to the optimum direction without being affected by, for example, the technique and experience of a sailor, the autonomous navigation ship 1 can navigate by maximally using the wind force as a propulsion force. In addition, the control device 13 controls the electric drive device 16 at all times or as necessary to drive the wing sail 7. An operation example of the wing sail 7 will be described later with reference to FIG. 6.

The positioning device 14 includes a global positioning system (GPS), and is a device that measures the current position of the hull 2. The positioning device 14 outputs the measured current position of the hull 2 to the autonomous navigation device 15.

The autonomous navigation device 15 stores map information and nautical chart information. The autonomous navigation device 15 controls the rudder 5, the electric motor 11, and the control device 13 to navigate the hull 2 from the current point to the destination point, based on the map information, the nautical chart information, the position of the destination point input in advance, and the current position of the hull 2 input from the positioning device 14.

Thus, the autonomous navigation ship 1 does not need to be maneuvered by a person and can navigate by automatic ship maneuvering using wind force and solar energy. In other words, the autonomous navigation ship 1 does not require an electric power cost for charging the battery 10, a fuel cost for driving an internal combustion engine, and a personnel cost for maneuvering the autonomous navigation ship. Therefore, according to the autonomous navigation ship 1, the cost required for navigation can be significantly reduced.

### 1-3. Navigation Attitude of Autonomous Navigation Ship According to First Embodiment

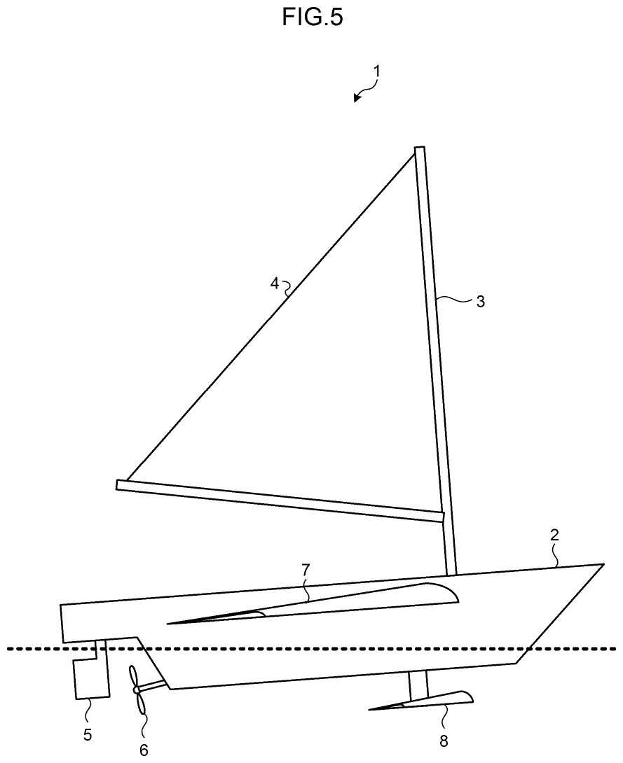

The navigation attitude of the autonomous navigation ship 1 according to the first embodiment will now be described with reference to FIG. 5. FIG. 5 is an explanatory side view of the autonomous navigation ship 1 according to the first embodiment during navigation.

As illustrated in FIG. 5, the autonomous navigation ship 1 moves forward by the propulsive force generated when the fore-and-aft sail 4 receives wind and the propulsive force generated when the screw 6 rotates. Note that the autonomous navigation ship 1 navigates without rotating the screw 6 when a necessary and sufficient navigation speed is obtained by the propulsive force by the fore-and-aft sail 4.

When the navigation speed is higher than or equal to a predetermined speed, the autonomous navigation ship 1 navigates while floating by the lift force generated by the wing sail 7 and the lift force generated by the hydrofoil 8. At this point, since the bottom of the autonomous navigation ship 1 has a V-shape in a front view (see FIG. 2), the contact area between the hull 2 and water is smaller than when the hull 2 does not float.

Thus, since the resistance force that the hull 2 receives from water is reduced, the navigation speed of the autonomous navigation ship 1 can be increased as compared with the case where the wing sail 7 and the hydrofoil 8 are not provided. In addition, the autonomous navigation ship 1 can further float the hull 2 by driving the wing sail 7.

### 1-4. Flapping Motion of Wing Sail According to First Embodiment

The flapping motion of the wing sail 7 according to the first embodiment will now be described with reference to FIG. 6. FIG. 6 is an explanatory view of the flapping motion of the wing sail 7 according to the first embodiment.

When the hull 2 cannot be sufficiently floated by the lift force by the hydrofoil 8 and the lift force by the wing sail 7 being in the fixed-wing state, or when the navigation speed is further increased, the autonomous navigation ship 1 drives the wing sail 7.

In this case, when the control device 13 of the autonomous navigation ship 1 receives a drive command of the wing sail 7 from the autonomous navigation device 15, the control device controls the electric drive device 16 to cause the wing sail 7 to perform the flapping motion by the electric drive device 16, as illustrated in FIG. 6. Thus, since the floating height of the hull 2 is higher than that in the case where the wing sail 7 is in the fixed-wing state, the navigation speed of the autonomous navigation ship 1 can be further increased.

### 1-5. Modification of First Embodiment

The first embodiment described above is an example, and the autonomous navigation ship 1 according to the first embodiment may be modified in various ways. The autonomous navigation ship 1 illustrated in FIGS. 1 to 6 includes the wing sail 7 and the hydrofoil 8, but may be configured to include at least one of the wing sail 7 and the hydrofoil 8. Thus, the weight of the autonomous navigation ship 1 is reduced, so that the navigation speed can be further increased.

In addition, when the autonomous navigation ship 1 is used for operating on a route with a relatively high wind speed, the autonomous navigation ship may be configured not to include the electric motor 11 and the screw 6. Thus, the autonomous navigation ship 1 can effectively utilize the space for the electric motor 11 as a space for loading, so that the loading capacity of the hull 2 can be enhanced.

Further, the shape of the wing sail 7 is not limited to the shape illustrated in FIGS. 1 to 6, and may be any shape as long as the wing sail has a shape that generates lift force. For example, the length of the wing sail 7 (the length in the width direction of the hull 2) is desirably two to three times the width of the hull 2.

In addition, the control device 13 may be configured to control the electric drive device 16 to adjust the pitch of the wing sail 7 in accordance with the wind direction and the wind speed such that the navigation speed of the hull 2 increases and the floating height of the hull 2 increases. Thus, the autonomous navigation ship 1 can navigate by making the most of the wind force.

Further, the control device 13 may be configured to control the wing sail 7 according to the weight of the hull 2. Specifically, when the weight of the cargo loaded on the autonomous navigation ship 1 increases, the weight of the hull 2 including the cargo increases and thus the ship has a deep draft. When the autonomous navigation ship 1 has a deep draft, the contact area between the hull 2 and water increases and thus the resistance that the ship receives from water increases.

Therefore, the control device 13 adjusts the pitch of the wing sail 7 so that the lift force by the wing sail 7 increases as the weight of the hull 2 including the cargo increases. Thus, the autonomous navigation ship 1 can more easily float in water, thereby reducing the resistance that the ship receives from water.

### 2. Second Embodiment

### 2-1. Appearance of Autonomous Navigation Ship According to Second Embodiment

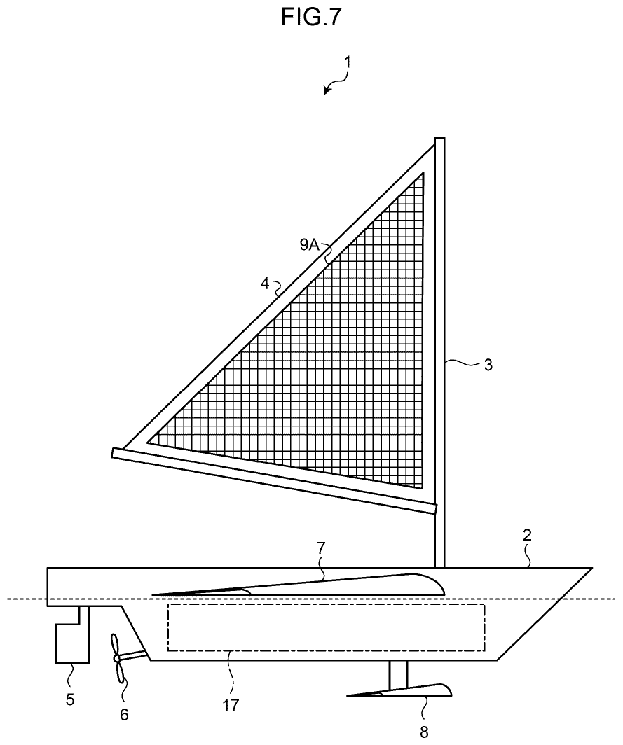

The appearance of the autonomous navigation ship 1 according to a second embodiment will now be described with reference to FIG. 7. FIG. 7 is an explanatory side view of the autonomous navigation ship 1 according to the second embodiment. Note that the appearance of the autonomous navigation ship 1 according to the second embodiment in a front view is the same as the appearance of the autonomous navigation ship 1 according to the first embodiment illustrated in FIG. 2 in a front view. In addition, the appearance of the autonomous navigation ship 1 according to the second embodiment in a top view is the same as the appearance of the autonomous navigation ship 1 according to the first embodiment illustrated in FIG. 3 in a top view.

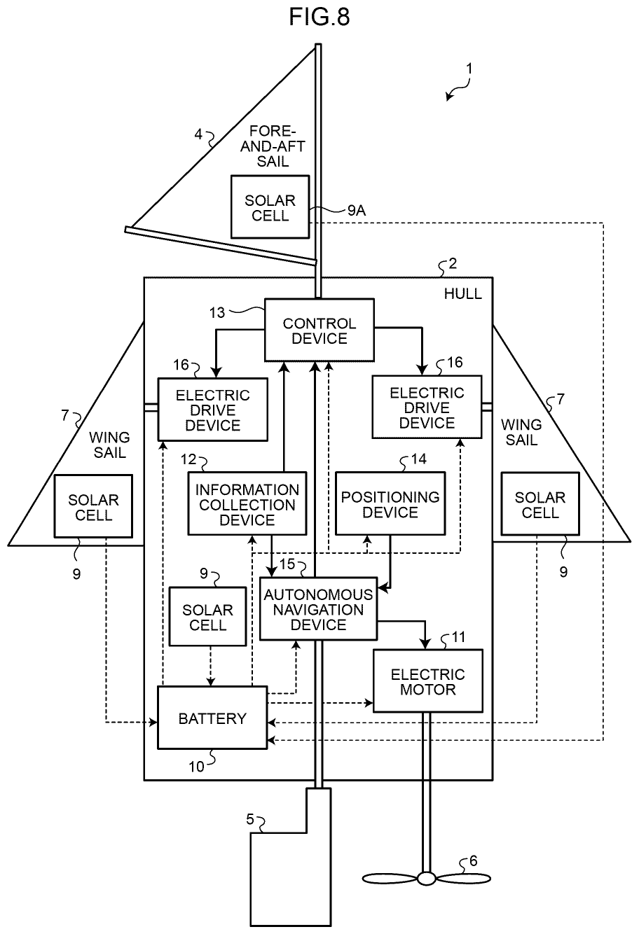

In the autonomous navigation ship 1 according to the second embodiment, a cloth-like (fibrous) solar cell 9A that converts sunlight into electricity is provided on the surface of the fore-and-aft sail 4. The solar cell 9A is, for example, a fabric or the like obtained by weaving a solar power generation yarn. The electric power generated by the solar cell 9A is supplied to the electric motor 11 (see FIG. 8) that drives the screw 6.

### 2-2. Internal Configuration of Autonomous Navigation Ship According to Second Embodiment

An internal configuration of the autonomous navigation ship 1 according to the second embodiment will now be described with reference to FIG. 8. FIG. 8 is a functional block diagram illustrating an internal configuration example of the autonomous navigation ship 1 according to the embodiment.

As illustrated in FIG. 8, the internal configuration of the autonomous navigation ship 1 according to the second embodiment is the same as the internal configuration of the autonomous navigation ship 1 according to the first embodiment illustrated in FIG. 4, except that the solar cell 9A is provided on the fore-and-aft sail 4 and the solar cell 9A is connected to the battery 10.

The battery 10 according to the second embodiment stores electricity generated by the solar panel 9 and the solar cell 9A, and supplies power to the electric motor 11, the information collection device 12, the control device 13, the positioning device 14, the autonomous navigation device 15, and the electric drive device 16.

In addition, the autonomous navigation device 15 stores map information and nautical chart information. The autonomous navigation device 15 calculates one or more candidates for a route from the departure point to the destination point, based on information including: the map information; the nautical chart information; the weather information and the ocean information input from the information collection device 12; the position of the departure point and the position of the destination point input in advance; and the current position of the hull 2 input from the positioning device 14. The autonomous navigation device 15 selects one of the calculated routes, and controls the rudder 5, the electric motor 11, and the control device 13 to navigate the hull 2 along the selected route.

### 2-3. Navigation Attitude of Autonomous Navigation Ship According to Second Embodiment

The navigation attitude of the autonomous navigation ship 1 according to the second embodiment is the same as the navigation attitude of the autonomous navigation ship 1 according to the first embodiment illustrated in FIG. 5.

### 2-4. Flapping Motion of Wing Sail According to Second Embodiment

The flapping motion of the wing sail 7 of the autonomous navigation ship 1 according to the second embodiment is the same as the flapping motion of the wing sail 7 of the autonomous navigation ship 1 according to the first embodiment illustrated in FIG. 6.

### 2-5. Selection of Route of Autonomous Navigation Ship According to Second Embodiment

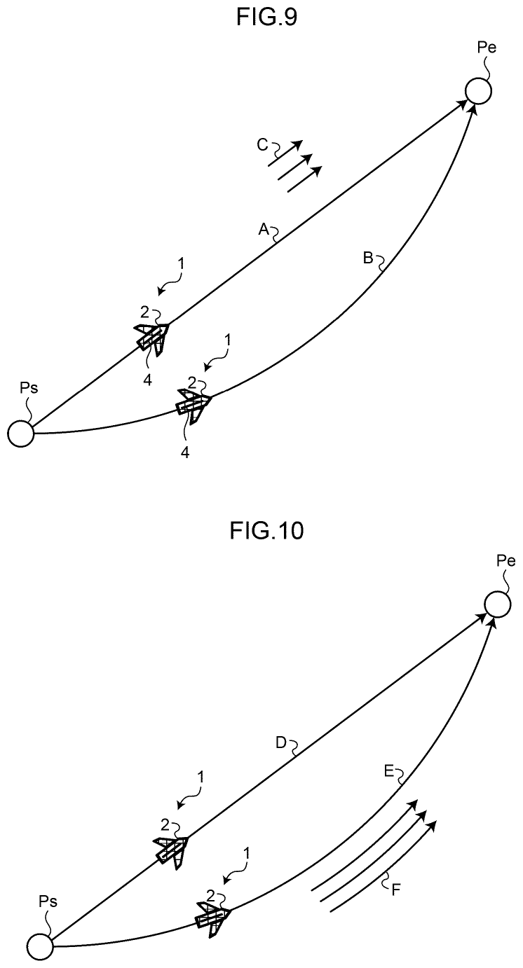

The selection of a route of the autonomous navigation ship 1 according to the second embodiment will now be described with reference to FIG. 9. FIG. 9 is an explanatory diagram illustrating selection of a route of the autonomous navigation ship 1 according to the second embodiment. Note that, for convenience of description, it is assumed that the autonomous navigation ship 1 navigates in a state where the fore-and-aft sail 4 is oriented in the same direction as the traveling direction of the autonomous navigation ship 1, but the orientation of the fore-and-aft sail 4 is not particularly limited.

It is assumed that the autonomous navigation device 15 calculates a route A and a route B as routes for navigating the hull 2 from a departure point Ps of the hull 2 to a destination point Pe of the hull 2, and the sunlight irradiation direction C is the same as the direction from the departure point Ps toward the destination point Pe.

Here, the route A is a route that navigates linearly from the departure point Ps to the destination point Pe, and is a route along the sunlight irradiation direction C. The route B is a route that navigates in a curved manner from the departure point Ps to the destination point Pe, and is a route that intersects the sunlight irradiation direction C.

In this case, as the difference between the traveling direction of the hull 2 and the sunlight irradiation direction C is larger, the sunlight irradiation angle to the fore-and-aft sail 4 is larger, so that the sunlight irradiation amount to the solar cell 9A in the route B is larger than that in the route A. In other words, the route in which the power generation amount of the solar cell 9A is maximized is the route B. The autonomous navigation device 15 selects the route B in which the power generation amount of the solar cell 9A is maximized, and navigates the hull 2 to the destination point Pe. Thus, in the case where the route B is selected, the length of the route is longer than that in the case where the route A is selected, but the amount of power generated by the solar cell 9A is increased, and the power cost for charging the battery 10 can be reduced.

Note that, instead of selecting a route from the departure point Ps to the destination point Pe in which the amount of power generated by the solar cell 9A is maximized, a route from the current position of the hull 2 to the destination point Pe in which the amount of power generated by the solar cell 9A is maximized may be selected. Further, in the present embodiment, the route in which the amount of power generated by the solar cell 9A is maximized is selected from the two routes (route A and route B), but the number of routes to be candidates for selection is not particularly limited.

### 2-6. Modification of Second Embodiment

The embodiment described above is an example, and the autonomous navigation ship 1 according to the second embodiment may be modified in various ways. The autonomous navigation ship 1 may select a route on an ocean current in which the drive of the screw 6 is minimized. The selection of a route on an ocean current in which the drive of the screw 6 is minimized will be described with reference to FIG. 10. FIG. 10 is an explanatory diagram of selection of a route of the autonomous navigation ship 1 according to the second embodiment. Note that the minimum drive of the screw 6 means that the electric power required to drive the screw 6 from the departure point Ps of the hull 2 to the destination point Pe of the hull 2 is minimum.

It is assumed that the autonomous navigation device 15 calculates a route D and a route E as routes for navigating the hull 2 from the departure point Ps to the destination point Pe, and the direction F of the ocean current is a direction in which the ocean current flows in an arc shape from the departure point Ps toward the destination point Pe. Here, the route D is a route that navigates linearly from the departure point Ps to the destination point Pe, and is a route that navigates to intersect an ocean current. The route E is a route that navigates in a curved manner from the departure point Ps to the destination point Pe, and is a route that navigates along an ocean current.

In this case, since the route E is capable of navigating to be carried by the ocean current, the route E does not require a propulsive force by electric power as compared with the route D. In other words, the route on the ocean current in which the drive of the screw 6 is minimized is the route E. The autonomous navigation device 15 selects the route E on the ocean current in which the drive of the screw 6 is minimized and navigates the hull 2 to the destination point Pe. Thus, when the route E is selected, the length of the route is longer than when the route D is selected, but the electric power required for navigation can be reduced.

Note that, instead of selecting a route on the ocean current in which the drive amount of the screw 6 from the departure point Ps to the destination point Pe is minimized, a route on the ocean current in which the drive amount of the screw 6 from the current position to the destination point Pe is minimized may be selected. In addition, instead of selecting a route on the ocean current in which the electric power required to drive the screw 6 to the destination point Pe is minimized, a route on the ocean current in which the drive time of the screw 6 is minimized may be selected. Further, in the second embodiment, the route on the ocean current in which the drive of the screw 6 is minimized is selected from the two routes (route D and route E), but the number of routes to be candidates for selection is not particularly limited.

### 3. Third Embodiment

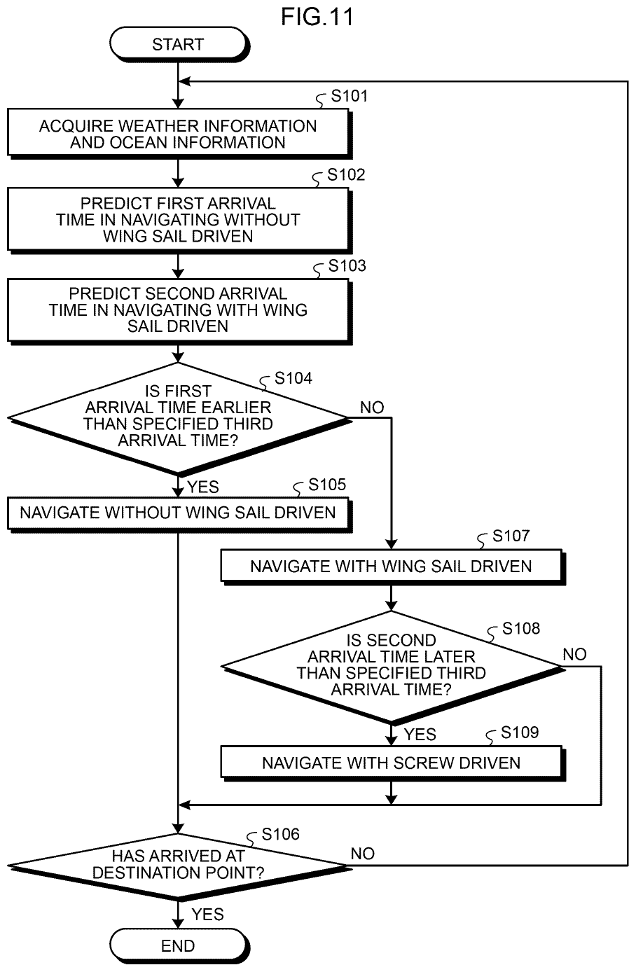

The appearance, the internal configuration, the navigation attitude, and the flapping motion of the fore-and-aft sail 4 of the autonomous navigation ship 1 according to a third embodiment are the same as those of the autonomous navigation ship 1 according to the first embodiment illustrated in FIGS. 1 to 6. However, the autonomous navigation ship 1 according to the third embodiment further performs the process illustrated in FIG. 11 in addition to the operation performed by the autonomous navigation device 15 according to the first embodiment. FIG. 11 is a flowchart illustrating an example of the process performed by the autonomous navigation device 15 according to the third embodiment.

The current position of the hull 2, the position of the destination point, the arrival time specified in advance, and the like are input and set in the autonomous navigation device 15 according to the third embodiment before the autonomous navigation ship 1 departs.

The autonomous navigation device 15 starts the process illustrated in FIG. 11 when the ship departs. Specifically, as illustrated in FIG. 11, the autonomous navigation device 15 according to the third embodiment first acquires weather information and ocean information from the information collection device 12 (Step S101).

Subsequently, based on the current position, the position of the destination point, the weather information, and the ocean information, the autonomous navigation device 15 calculates and predicts an arrival time (hereinafter referred to as a “first arrival time”) to the destination point in a case of navigating without the wing sail 7 driven (Step S102).

At this point, the autonomous navigation device 15 refers to the weather information and predicts the first arrival time such that the first arrival time is earlier as the wind direction of the tailwind is closer to the target traveling direction of the autonomous navigation ship 1 and the wind speed thereof is higher.

In addition, the autonomous navigation device 15 refers to the ocean information, and predicts the first arrival time such that the first arrival time is earlier as the direction of the ocean current is closer to the target traveling direction of the autonomous navigation ship 1 and the flow velocity thereof is higher.

Further, based on the current position, the position of the destination point, the weather information, the ocean information, and the performance of the wing sail 7, the autonomous navigation device 15 calculates and predicts an arrival time (hereinafter referred to as a “second arrival time”) to the destination point in a case of navigating with the wing sail 7 driven (Step S103).

At this point, the autonomous navigation device 15 refers to the weather information and predicts the second arrival time such that the second arrival time is earlier as the wind direction of the tailwind is closer to the target traveling direction of the autonomous navigation ship 1 and the wind speed thereof is higher.

In addition, the autonomous navigation device 15 refers to the ocean information and predicts the second arrival time such that the second arrival time is earlier as the direction of the ocean current is closer to the target traveling direction of the autonomous navigation ship 1 and the flow velocity thereof is higher. Note that it is assumed that the performance of the wing sail 7 is a known performance in design according to the size and the shape of each wing sail 7 different for each type of the wing sail 7.

Thereafter, the autonomous navigation device 15 determines whether or not the first arrival time is earlier than an arrival time (hereinafter referred to as a “third arrival time”) specified in advance to the destination point (Step S104).

If the autonomous navigation device 15 determines that the first arrival time is earlier than the third arrival time (Step S104, Yes), the autonomous navigation device controls, by the control device 13, the electric drive device 16 to navigate without the wing sail 7 driven (Step S105), and moves the process to Step S106.

In addition, if the autonomous navigation device 15 determines that the first arrival time is not earlier than the third arrival time (Step S104, No), the autonomous navigation device controls, by the control device 13, the electric drive device 16 to navigate with the wing sail 7 driven (Step S107).

In other words, if the first arrival time is later than the third arrival time, or if the first arrival time and the second arrival time are the same time, the autonomous navigation device 15 controls, by the control device 13, the electric drive device 16 to navigate with the wing sail 7 driven. Thereafter, the autonomous navigation device 15 determines whether or not the second arrival time is later than the third arrival time (Step S108).

If the autonomous navigation device 15 determines that the second arrival time is later than the third arrival time (Step S108, Yes), the autonomous navigation device controls the electric motor 11 to navigate with the screw 6 driven (Step S109), and moves the process to Step S106.

In addition, if the autonomous navigation device 15 determines that the second arrival time is not later than the third arrival time (Step S108, No), the autonomous navigation device moves the process to Step S106. In other words, if the second arrival time is earlier than the third arrival time, or if the second arrival time and the third arrival time are the same time, the autonomous navigation device 15 moves the process to Step S106.

In Step S106, the autonomous navigation device 15 determines whether or not the autonomous navigation device has arrived at the destination point. If the autonomous navigation device 15 then determines that the autonomous navigation device has not arrived at the destination point (Step S106, No), the autonomous navigation device moves the process to Step S101. In addition, if the autonomous navigation device 15 determines that the autonomous navigation device has arrived at the destination point (Step S106, Yes), the autonomous navigation device ends the process.

As described above, the autonomous navigation device 15 according to the third embodiment predicts the first arrival time at the destination point in a case of navigating without the wing sail 7 driven and the second arrival time at the destination point in a case of navigating with the wing sail 7 driven. If the first arrival time is earlier than the third arrival time specified in advance to the destination, the autonomous navigation device 15 according to the third embodiment then controls, by the control device 13, the electric drive device 16 to navigate without the wing sail 7 driven.

In other words, if the autonomous navigation device 15 according to the third embodiment can arrive at the destination point before the specified time without driving the wing sail 7, the autonomous navigation device navigates only by the lift force of the wing sail 7 in the fixed state and the propulsive force of the fore-and-aft sail 4.

Thus, the autonomous navigation ship 1 according to the third embodiment does not require fuel for driving an internal combustion engine and also does not require power consumption for driving the wing sail 7, so that the cost required for navigation can be reduced by reducing the power cost for charging the battery 10. In addition, the autonomous navigation ship 1 according to the third embodiment can effectively use the remaining charge amount of the battery 10 saved in the above-described navigation for the next navigation.

If the first arrival time is later than the third arrival time, the autonomous navigation device 15 according to the third embodiment controls, by the control device 13, the electric drive device 16 to navigate with the wing sail 7 driven. Thus, the autonomous navigation ship 1 according to the third embodiment navigates by using both the lift force and propulsive force of the wing sail 7 and the propulsive force of the fore-and-aft sail 4, so that the arrival time to the destination point can be brought closer to the specified time that cannot be met only by the propulsive force of the fore-and-aft sail 4.

In addition, if the second arrival time is later than the third arrival time, the autonomous navigation device 15 according to the third embodiment controls, by the control device 13, the electric drive device 16 to navigate with the wing sail 7 driven, and controls the electric motor 11 to navigate with the screw 6 driven.

Thus, the autonomous navigation ship 1 according to the third embodiment navigates by using the lift force and propulsive force of the wing sail 7, the propulsive force of the fore-and-aft sail 4, and the propulsive force of the screw 6, so that the arrival time to the destination point can be further brought closer to the specified time.

### 4. Fourth Embodiment

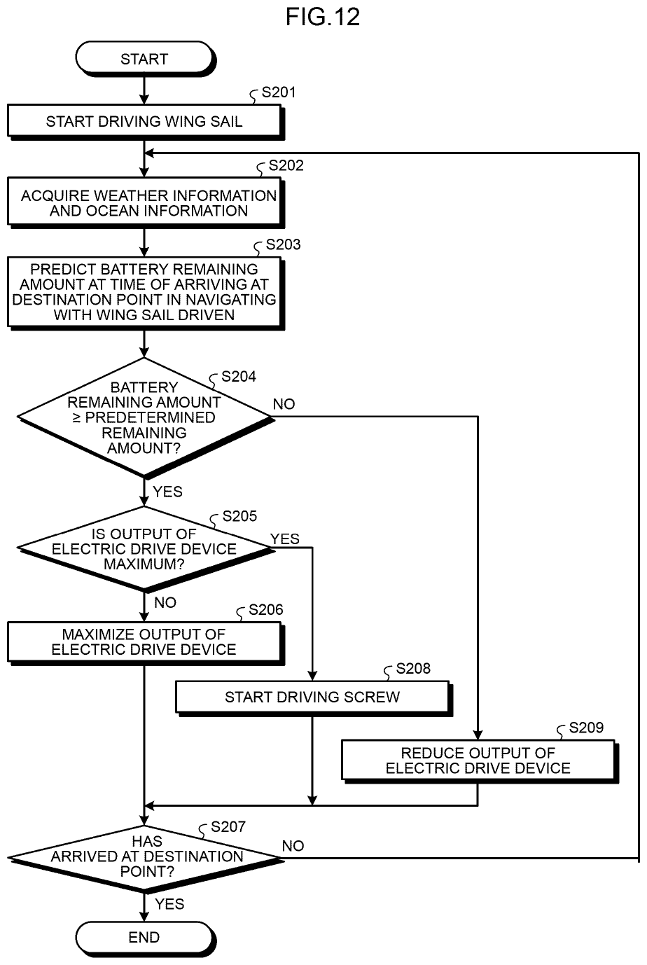

The appearance, the internal configuration, the navigation attitude, and the flapping motion of the fore-and-aft sail 4 of the autonomous navigation ship 1 according to a fourth embodiment are the same as those of the autonomous navigation ship 1 according to the first embodiment illustrated in FIGS. 1 to 6. However, the autonomous navigation ship 1 according to the fourth embodiment further performs the process illustrated in FIG. 12 in addition to the operation performed by the autonomous navigation device 15 according to the first embodiment.

FIG. 12 is a flowchart illustrating an example of the process performed by the autonomous navigation device 15 according to the fourth embodiment.

The current position of the hull 2, the position of the destination point, the arrival time specified in advance, and the like are input and set in the autonomous navigation device 15 according to the fourth embodiment before the autonomous navigation ship 1 departs.

The autonomous navigation device 15 according to the fourth embodiment starts the process illustrated in FIG. 12 when the ship departs. Specifically, as illustrated in FIG. 12, the autonomous navigation device 15 first starts driving the wing sail 7 (Step S201). Thereafter, the autonomous navigation device 15 acquires weather information and ocean information from the information collection device 12 (Step S202).

Subsequently, the autonomous navigation device 15 predicts the remaining amount of the battery 10 at the time of arriving at the destination point by navigating with the wing sail 7 driven, based on the performance of the wing sail 7, the weather information, and the ocean information (Step S203).

At this point, the autonomous navigation device 15 refers to the weather information and predicts the remaining amount of the battery 10 such that the remaining amount of the battery 10 increases as the amount of sunlight received by the solar panel 9 increases. In addition, the autonomous navigation device 15 refers to the weather information and predicts the remaining amount of the battery 10 such that the remaining amount of the battery 10 increases as the wind direction of the tailwind is closer to the target traveling direction of the autonomous navigation ship 1 and the wind speed thereof is higher.

In addition, the autonomous navigation device 15 refers to the ocean information and predicts the remaining amount of the battery 10 such that the remaining amount of the battery 10 increases as the direction of the ocean current is closer to the target traveling direction of the autonomous navigation ship 1 and the flow velocity thereof is higher. Note that it is assumed that the performance of the wing sail 7 is a known performance in design according to the size and the shape of each wing sail 7 different for each type of the wing sail 7.

The autonomous navigation device 15 then determines whether or not the predicted remaining amount of the battery is greater than or equal to a predetermined remaining amount (Step S204). The predetermined remaining amount is a lower limit value of the remaining amount of the battery 10 at which the performance of the battery 10 can be guaranteed even if the battery 10 is deteriorated.

If the autonomous navigation device 15 determines that the predicted remaining amount of the battery 10 is greater than or equal to the predetermined remaining amount (Step S204, Yes), the autonomous navigation device determines whether or not the output of the electric drive device 16 is maximum (Step S205).

If the autonomous navigation device 15 determines that the output of the electric drive device 16 is not maximum (Step S205, No), the autonomous navigation device controls the control device 13 to maximize the output of the electric drive device 16 (Step S206), and moves the process to Step S207.

In addition, if the autonomous navigation device 15 determines that the output of the electric drive device 16 is maximum (Step S205, Yes), the autonomous navigation device drives the electric motor 11 that rotates the screw 6 (Step S208), and moves the process to Step S207.

In addition, if the autonomous navigation device 15 determines that the remaining amount of the battery 10 is not greater than or equal to the predetermined remaining amount (Step S204, No), the autonomous navigation device reduces the output of the electric drive device 16 (Step S209) and moves the process to Step S207.

In other words, if the autonomous navigation device 15 determines that the remaining amount of the battery 10 is less than the predetermined remaining amount, the autonomous navigation device reduces the output of the electric drive device 16 and then moves the process to Step S207.

In Step S207, the autonomous navigation device 15 determines whether or not the autonomous navigation device has arrived at the destination point. If the autonomous navigation device 15 then determines that the autonomous navigation device has not arrived at the destination point (Step S207, No), the autonomous navigation device moves the process to Step S202. In addition, if the autonomous navigation device 15 determines that the autonomous navigation device has arrived at the destination point (Step S207, Yes), the autonomous navigation device ends the process.

As described above, the autonomous navigation device 15 according to the fourth embodiment predicts the remaining amount of the battery 10 at the time of arriving at the destination point by navigating with the wing sail 7 driven, based on the weather information and the ocean information. If the autonomous navigation device 15 according to the fourth embodiment then determines that the remaining amount of the battery 10 is greater than or equal to the predetermined remaining amount, the autonomous navigation device controls the control device 13 to maximize the output of the electric drive device 16.

In other words, the autonomous navigation ship 1 according to the fourth embodiment navigates to the destination point by maximizing the lift force and propulsive force of the wing sail 7 if the remaining amount of the battery 10 does not fall below the predetermined remaining amount even if the navigation with the wing sail 7 driven is continued to the destination point. Thus, the autonomous navigation ship 1 according to the fourth embodiment can suppress the deterioration of the battery 10 and the delay of the arrival time at the destination point.

In addition, the autonomous navigation device 15 according to the fourth embodiment controls the control device 13 to reduce the output of the electric drive device 16 if the autonomous navigation device determines that the remaining amount of the battery 10 is less than the predetermined remaining amount based on the changes in the weather information and the ocean information during the navigation with the output of the electric drive device 16 maximized.

In other words, the autonomous navigation ship 1 according to the fourth embodiment reduces the output of the electric drive device 16 if the remaining amount of the battery 10 at the time of arriving at the destination point falls below the predetermined remaining amount when the weather information or the ocean information changes during navigation and the output of the electric drive device 16 continues to be maximized. Thus, the autonomous navigation ship 1 according to the fourth embodiment can suppress the deterioration of the battery 10 even when the weather and ocean conditions change during navigation.

The autonomous navigation device 15 according to the fourth embodiment includes the electric motor 11 that drives the screw 6 that applies a propulsive force to the hull 2. The autonomous navigation device 15 according to the fourth embodiment then drives the electric motor 11 if the autonomous navigation device determines that the remaining amount of the battery 10 is greater than or equal to the predetermined remaining amount based on the changes in the weather information and the ocean information during navigation with the output of the electric drive device 16 maximized.

In other words, the autonomous navigation ship 1 according to the fourth embodiment navigates by using the propulsive force of the screw 6 in addition to the lift force and the propulsive force of the wing sail 7, if the autonomous navigation ship predicts that there is a margin in the remaining amount of the battery 10 even when the autonomous navigation ship navigates to the destination point with the output of the electric drive device 16 maximized. Thus, the autonomous navigation ship 1 according to the fourth embodiment can further advance the arrival time at the destination point.

Further effects and modifications can be easily derived by those skilled in the art. Therefore, the broader aspects of the present invention are not limited to the specific details and representative embodiments illustrated and described above. Accordingly, various modifications may be made without departing from the spirit or scope of the general inventive concept as defined by the appended claims and their equivalents.

### REFERENCE SIGNS LIST

1 AUTONOMOUS NAVIGATION SHIP
2 HULL
3 MAST
4 FORE-AND-AFT SAIL
5 RUDDER
6 SCREW
7 WING SAIL
8 HYDROFOIL
9 SOLAR PANEL
10 BATTERY
11 ELECTRIC MOTOR
12 INFORMATION COLLECTION DEVICE
13 CONTROL DEVICE
14 POSITIONING DEVICE
15 AUTONOMOUS NAVIGATION DEVICE
16 ELECTRIC DRIVE DEVICE
17 SPACE

1. An autonomous navigation ship comprising:
a hull;
a fore-and-aft sail stretched on a mast erected on the hull;
an information collection device that collects weather information and ocean information around the hull;
a control device that controls a direction of the fore-and-aft sail such that a propulsive force of the hull is maximized, based on the weather information and the ocean information collected by the information collection device;
a positioning device that measures a position of the hull;
an autonomous navigation device that controls a rudder to navigate the hull from a current position to a destination point, based on the position of the hull measured by the positioning device; and
a wing sail that is provided on both sides of the hull and floats the hull by applying a lift force to the hull during navigation.

2. The autonomous navigation ship according to claim 1, comprising
an electric motor that drives a screw that applies a propulsive force to the hull, wherein
the wing sail
is provided with a solar panel that generates electric power to be supplied to the electric motor.

3. The autonomous navigation ship according to claim 1, comprising an electric drive device that causes the wing sail to perform a flapping motion.

4. The autonomous navigation ship according to claim 1, comprising
a hydrofoil that is provided at a bottom of a ship and floats the hull by applying a lift force to the hull during navigation.

5-8. (canceled)

9. An autonomous navigation ship comprising:
a hull;
a fore-and-aft sail stretched on a mast erected on the hull;
a wing sail that is provided on both sides of the hull and floats the hull by applying a lift force to the hull during navigation;
an electric drive device that causes the wing sail to perform a flapping motion;
an information collection device that collects weather information and ocean information around the hull;
a control device that controls operations of the fore-and-aft sail and the wing sail such that a propulsive force of the hull is maximized, based on the weather information and the ocean information collected by the information collection device;
a positioning device that measures a position of the hull; and
an autonomous navigation device that controls a rudder to navigate the hull from a current position to a destination point, based on the position of the hull measured by the positioning device, wherein
the autonomous navigation device
predicts a first arrival time to the destination point in a case of navigating without the wing sail driven and a second arrival time to the destination point in a case of navigating with the wing sail driven, and
if the first arrival time is earlier than a third arrival time specified in advance to the destination point, the autonomous navigation device controls, by the control device, the electric drive device to navigate without the wing sail driven.

10. The autonomous navigation ship according to claim 9, wherein
if the first arrival time is later than the third arrival time, the autonomous navigation device
controls, by the control device, the electric drive device to navigate with the wing sail driven.

11. The autonomous navigation ship according to claim 10, comprising
an electric motor that drives a screw that applies a propulsive force to the hull, wherein
if the second arrival time is later than the third arrival time, the autonomous navigation device
controls, by the control device, the electric drive device to navigate with the wing sail driven, and controls the electric motor to navigate with the screw driven.

12. An autonomous navigation ship comprising:
a hull;
a fore-and-aft sail stretched on a mast erected on the hull;
a wing sail that is provided on both sides of the hull and floats the hull by applying a lift force to the hull during navigation;
an electric drive device that causes the wing sail to perform a flapping motion;
a battery that supplies electric power to the electric drive device;
an information collection device that collects weather information and ocean information around the hull;
a control device that controls operations of the fore-and-aft sail and the wing sail such that a propulsive force of the hull is maximized, based on the weather information and the ocean information collected by the information collection device;
a positioning device that measures a position of the hull; and
an autonomous navigation device that controls a rudder to navigate the hull from a current position to a destination point, based on the position of the hull measured by the positioning device, wherein
the autonomous navigation device
predicts a remaining amount of the battery at a time of arriving at the destination point by navigating with the wing sail driven based on the weather information and the ocean information, and controls, if the autonomous navigation device determines that the remaining amount of the battery is greater than or equal to a predetermined remaining amount, the control device to maximize the output of the electric drive device.

13. The autonomous navigation ship according to claim 12, wherein
the autonomous navigation device
controls the control device to reduce the output of the electric drive device if the autonomous navigation device determines that the remaining amount of the battery is less than the predetermined remaining amount based on changes in weather information and ocean information during navigation with the output of the electric drive device maximized.

14. The autonomous navigation ship according to claim 12, comprising
an electric motor that drives a screw that applies a propulsive force to the hull, wherein
the autonomous navigation device
drives the electric motor if the autonomous navigation device determines that the remaining amount of the battery is greater than or equal to the predetermined remaining amount based on changes in weather information and ocean information during navigation with the output of the electric drive device
